(19) United States
(12) Patent Application Publication
(10) Pub. No.: US 2016/0042133 A1
(43) Pub. Date: Feb. 11, 2016

(54) SYSTEM AND METHOD FOR BEHAVIORAL HEALTH CASE MANAGEMENT

(71) Applicant: Mindoula Health, Inc., Silver Spring, MD (US)

(72) Inventor: Steven Sidel, Bethesda, MD (US)

(21) Appl. No.: 14/755,092

(22) Filed: Jun. 30, 2015

Related U.S. Application Data
(60) Provisional application No. 62/018,873, filed on Jun. 30, 2014.

(51) Int. Cl. G06F 19/00

(52) U.S. Cl. CPC G06F 19/345; G06F 19/322; G06Q 2220/10

(57) ABSTRACT

In a data processing network comprising two or more remote workstations, such as a personal computer, mobile phone, tablet, or the like, at least one application server and at least one secure, HIPPA-compliant database management system, all connected over one or more communications networks enabling the transmission of both data and voice phone calls, a system for efficient, cost-effective, scalable, evidenced based case management for individuals suffering from mental illness. The system enables patient communication with an assigned care manager, who assists the patient with collecting and analyzing disparate elements of the patient's health records and data, navigating the mental health care system, making and keeping appointments, and tracking medication and treatment. The system also provides means for 24/7 personal communication and state assessment between patient and care manager. The method consists of administering a Discovery Assessment, logging all generated health care data, and revising the treatment and/or medication protocols based on same.

### CROSS REFERENCE TO RELATED APPLICATIONS

This application claims the benefit of U.S. Provisional Patent Application No. 62/018,871 filed Jun. 30, 2014 and titled “System and Method for Behavioral Health Case Management”, which is incorporated herein in its entirety by reference.

### BACKGROUND OF THE INVENTION

1. Field of the Invention

The system and method described herein relate to the field of behavioral health case management, more particularly, to the field of software for behavioral health case management.

2. Description of the Background

The prevalence of mental illness represents a pressing public health issue in the United States. A 2012 National Survey on Drag Use and Health reported that 43.7 million American adults experienced mental illness in the year prior, a figure that represents nearly 20% of the entire US adult population. According to the same study, within this larger estimate, 9.6 million American adults reported living with a serious mental illness (SMI), a designation that includes conditions such as schizophrenia, bipolar disorder, and major depressive disorder. Additional studies have shown that 46.4% of Americans have experienced a disorder at some point in their lifetime, with 27.7% experiencing two disorders and 17.3% experiencing three or more disorders, with some studies and reviews suggesting that the lifetime prevalence of schizophrenia is around 1%.

Other measures of the impact of illness further underscore the negative consequences of mental illness. Disability-adjusted life year (DALY), a measure of overall burden of disease used by the World Health Organization (WHO), combines the amount of years of life lost to disease with the amount of years of life one spent at less than full health due to a disease. By this measure, studies have shown that unipolar depressive disorders cause the third highest global burden of any type of disease, with 65.5 million DALYs attributable to these conditions. In middle and high-income countries, unipolar depressive disorders have been shown to be the single most burdensome illness, accounting for 8 percent of all DALYs in high-income countries. This trend is only getting worse, as estimates suggest that by the year 2030, unipolar depressive disorders are projected to become the single most burdensome illness in the world.

Mental illness is associated with an increased risk of morbidity in a variety of areas. For example, it has been estimated that 68% of adults with mental disorders also have medical conditions, a prevalence that is substantially higher than that found in the general US population. A bi-directional relationship between physical and mental illness has also been observed. Common chronic physical conditions, including obesity and diabetes have been linked to an increased risk of depression and mental illness. In addition, individuals with mental illness are at increased risk for medical conditions.

The impact of mental illness on the individual goes beyond physical, and emotional health, as well. For example, early-onset mental illness accounts for significantly lower educational attainment. There is an especially large impact on schooling termination at the high school level, with an estimated 10.2% of all high-school terminations attributable to mental illness. In addition to educational achievement, mental illness has a deleterious impact on employment and productivity. A diagnosis of a mental illness in the previous four months has been shown to be predictive of substantially reduced earnings. In 2002, it was estimated that the US lost up to 193.2 billion dollars due to the reduced earning potential of individuals with mental disorders. These results are consistent with WHO evaluations of international patterns of reduced earning potential among people with a mental disorder.

Mental illness is also costly at the business level, as mental illness and substance abuse indirectly cost employers an estimated $80 to $100 billion annually, with approximately $44 billion of that due to lost productivity. Additional studies have shown that, at the individual level, depression and other mental illness are associated with an economic cost of $348 per eligible employee per year, the third highest of the surveyed health condition categories. In addition, workers with depression lost about 5.6 productive hours of work per week, compared to 1.5 for workers without depression. Furthermore, workers at high risk for depression have been found to be 48% more expensive to their employers than those who are not at high risk. These figures are a product of the estimated 217 million workdays that are partially or completely lost due to mental illness in America every year.

In addition to the negative impact on those that suffer from mental illness, there is also a considerable impact on their family, friends and dependents. The deinstitutionalization of mental health care resulted in many individuals with SMI living with parents or other family members, rather than in a specialized care facility. As a result, parents of a son or daughter with SMI living at home must be concerned with their symptoms, as well as with attending to daily needs such as food, self-care, and financial support. These additional responsibilities create significant challenges for the parents, and have been shown to lead to increased anxiety, frustration and grief for the caregivers. Furthermore, spouses of individuals suffering from mental illness have been found to have lower quality of life, and may be at higher risk of developing a mental disorder themselves.

While the prevalence of mental illness in the US is substantial, of even more concern is the tack of adequate care available to those with mental illness. According to a 2005 study, only 4.1% of those with any mental illness and 62.9% of those with SMI had received mental health services in the past year. Of those with mental illness, only 12.3% were treated by a psychiatrist and 16% by a mental health specialist other than a psychiatrist. Those who did not see a mental health specialist either did not receive treatment, received mental healthcare from their general medical provider, or received services from a complementary/alternative medical provider. There is a widespread shortage of specialty mental health care in the US, as estimates suggest that up to 96% of US counties have a shortage of mental health professionals. A further study suggested that filling the gap between the need for services and the supply of mental health professionals would require 54,462 prescribing and 68,581 non-prescribing professionals. In addition, estimates suggest that only 55% of psychiatrists in the U.S. accept private insurance in their practice, and only 43% accept Medicaid, both of which are significantly lower than any other medical specialty.

Despite the dearth of mental health services available, a significant amount of money is spent each year in this market, with estimates suggesting that the US government alone spends more than 150 billion dollars annually. Mental healthcare spending in the US totaled $172 billion between public and private sources in 2009. These amounts make up only 7.4% of healthcare spending in the US, a proportion that is out of line with the fact that mental illness accounts for a larger portion of disability in the US than any other group of illnesses. Considering all of these societal costs, it has been estimated by the National Institute of Mental Health that the US loses nearly 300 billion dollars annually due to costs of mental illness.

Furthermore, even those who do receive some treatment may not have access to minimally adequate care. Estimates suggest that four of every five people in the US suffering from mental illness do not receive effective treatment. When looking only at those suffering from SMI, the proportion receiving effective care drops to 15%. This is due in part to both a shortage of mental health professionals in the US and to a limited proportion of mental health professionals accepting government-provided and private health insurance.

For several years, case management has served an important role in community mental health care. The role of a case manager was traditionally conceptualized as an entity that coordinates, integrates, and allocates care within limited resources.” However, as case management's use has grown and it has been adapted for a variety of clientele and purposes, it has become clear that this definition does not encompass all that modern case management represents. As other reports have noted, the term “case management” can be a misnomer, as the day-to-day responsibilities of professionals with this title can go far beyond traditional views of this term. The Case Management Society of America has defined case management as “a collaborative process of assessment, planning, facilitation, care coordination, evaluation, and advocacy for options and services to meet an individual's and family's comprehensive health needs through communication and available resources to promote quality, cost-effective outcomes.” While these general responsibilities represent much of what case managers do for their clients, the day-to-day responsibilities of a case manager can vary widely as a function of specific client needs. Further clouding the issue of defining the role of a case manager, the responsibilities specific to case management exist within a variety of organizational contexts. For example, the responsibilities of case management role may be handled by an individual case manager, may be subsumed as a component of a healthcare team, or may be one of many responsibilities given to an allied health provider, such as a clinical social worker or nurse. In each of these situations, the exact responsibilities that make up case management can vary substantially, and as a result so can the client's experience of and with, case management.

Reviews of case management for SMI in particular have shown it to be associated with reduction of symptoms, as well as with improved social functioning, quality of life, patient satisfaction and housing stability. There are, however, significant barriers to providing case management services. Due to the time consuming nature of the job and the potentially high-stress work environment, there is both a low supply of and very high turnover for case managers. As a result, in practice, it is uncommon for case managers to have small enough caseloads to allow for a truly time-unlimited, 24-7 service. Another practical concern is that case management is usually not reimbursable, leading to a high cost and low accessibility of the service.

In addition, the exact components of case management that improve outcomes are not currently known. Most prior art case management services do not define their client populations clearly and do not have rigorous standardization for either assessment or intervention, limiting inferences that can be made from any resulting positive outcomes. Many prior art methods also do not have the benefit of documentation regarding the characteristics of users of community mental health and case management, beyond the fact that schizophrenia is disproportionately present in this population. In order to better address the needs that case management may effectively address, higher quality information regarding client characteristics is needed.

In recent years, communication technologies have started to play a larger role in the administration of health care services. For example, technologies such as the Internet and smartphones have been used in the development of behavioral health interventions. The use of such communication technologies in healthcare is referred to as “telemedicine.” Telemental health, the mental health counterpart to telemedicine, is another way to provide access to mental health services beyond the scope of traditional care, for example, via telephone-administered psychotherapy for depression. Promisingly, early evaluations of (elemental health interventions for posttraumatic stress disorder (PTSD), substance abuse, and panic disorder have indicated equivalent effectiveness in symptom reduction to those achieved by in-person treatment. In addition, Internet-based cognitive behavioral therapy (CBT), used with mental health conditions ranging from anxiety and depression to PTSD to complicated grief, has generally been shown to result in similar improvement of symptoms as in-person therapy, and in some populations Internet treatments have shown longer-term benefits.

However, most of the existing telemental health technologies demonstrate a significant lack of standardization in their development. Furthermore, while many existing communications applications may assist with individual components of evidence-based behavioral treatment, few offer support across multiple stages of the treatment process. Instead, existing solutions focus primarily on the provision of information to patients or on teletherapy. Moreover, no prior art system offers a HIPAA-compliant communication platform for telephone-based communications between case managers and their clients, which are most often delivered through commonly used consumer text and email platforms and the case manager's personal cellphone.

In the area of chronic physical illness care, telephonic case management has been associated with increased patient satisfaction, care plan compliance and self-management, and has been supported as reducing overall costs of healthcare. However, evidence supporting the effectiveness of communication technology assisted case management for behavioral health is extremely limited, and new systems evaluating the effectiveness of such a widespread protocol are clearly needed.

The prior art demonstrates the lack of an a scalable technology platform that makes use of predictive analytics to enable case managers to provide or facilitate evidenced-based interventions and use such synchronous and asynchronous data to provide virtual population management services to physicians practices, treatment centers, hospitals and other entities that would benefit greatly from such services.

Moreover, behavioral health treatment providers will generally meet with a patient in person once a day at most, and generally, do not want to give patients 24 hour access to them to avoid off-hour calls. Therefore, a patient could have an acute mental health crisis when the behavioral health treatment provider is busy or off the clock, with potentially disastrous results. Therefore, a way to monitor patients 24/7 and provide case management on an as-needed basis is needed in the art.

In addition, primary care physicians (PCPs) are not systemically connected, to psychiatrists and other behavioral health providers, and do not have access to virtual case managers, impairing PCP's ability to effectively treat behavioral health patients. Therefore, a way to facilitate these connections between PCPs and behavior health providers using virtual case managers is needed in the art.

There is, therefore, a need for novel interventions that are effective, cost-efficient, and scalable to reach the millions of individuals who are suffering from mental illness and do not have access to adequate care. In addition, there is a need for a multiplatform case management service wherein all aspects of the platform, including text, email, phone, and video chat are HIPAA compliant.

### SUMMARY OF THE INVENTION

Accordingly, the present invention is a software-enabled method of behavioral health case management including: generating a software-assisted client assessment; receiving and storing the client assessment; receiving open-ended communication from the client during the treatment process; analyzing the client's open-ended communication for indications of behavioral health problems; determining, based on the assessments, client's data inputs, and data inputs from the client's care manager, treatment providers and other privileged parties, and analysis of said data, if an intervention is necessary; generating communications for the client, treatment providers, care manager, and/or other privileged parties to assist the client in scheduling and maintaining treatment regimens, tracking and/or modifying medications and treatment regimens as necessary, and monitoring client physical and mental health and behavior on a 24/7 basis; and storing the client's medical information and other useful resources in an easily-accessible manner for the client, care manager, treatment provider(s), and/or other privileged parties.

The method according to the present invention also composes pairing a client with one or more care managers to assist the client in managing his or her mental health care, treatment, medications and activity levels. The method also includes means to enable a care manager to easily review the status, mental health care, treatment, medications and activity levels of each of his or her client(s) in a single location and/or via a mobile application for efficient care management of all clients. It also includes means to enable and prompt regular check-ins of client status and progress during mental health treatment.

The method according to the present invention demonstrates efficiency and cost savings in the realm of mental health treatment by allowing the functions traditionally performed by hospital, doctor's office, or private case managers, as well as additional functions useful in assisting client's in managing their total mental health care, to fall under one inefficient and scalable system wherein the case manager is intimately connected with the workings of the client's primary care physician, psychiatrist, and/or other treatment providers.

In addition, the system according to the present invention allows for tracking, logging, and analysis of all mental health care data for each client and system analysis and comparison of health care data across a broad spectrum of patients to allow for development of improved methods for treatment of mental health issues.

The behavioral case management method according to the present invention may be implemented in a data processing network comprising two or more remote workstations, such as a personal computer, mobile phone, tablet, or the like, at least one application server and at least one secure, HIPPA-compliant database management system, all connected over one or more communications networks enabling the transmission of both data and voice phone calls. In certain embodiments, the data processing network on which the present invention is implemented involves at least one land-line telephone and at least one facsimile machine.

### BRIEF DESCRIPTION OF THE DRAWINGS

FIG. 1(a) is a diagram of the system architecture according to one embodiment of the present invention.

FIG. 1(b) is a diagram of the system according to one embodiment of the present invention.

FIG. 2(a) is a screenshot of the case manager dashboard according to one embodiment of the present invention.

FIG. 2(b) is a screenshot of the case manager dashboard according to one embodiment of the present invention.

FIG. 2(c) is a screenshot of the case manager dashboard according to one embodiment of the present invention.

FIG. 3 is a screenshot of the case manager dashboard displaying aggregated data for a single patient according to one embodiment of the present invention.

FIG. 4 is a screenshot of aggregated patient data for use by the case manager according to one embodiment of the present invention.

FIG. 5 is a screenshot of the provider portal used to facilitate collaborative care according to one embodiment of the present invention.

FIG. 6(a) is a screenshot of a patient texting function integrated with patient inputs according to one embodiment of the present invention.

FIG. 6(b) is a screenshot of a patient texting function integrated with patient inputs according to one embodiment of the present invention.

FIG. 6(c) is a screenshot of a patient texting function integrated with patient inputs according to one embodiment of the present invention.

### DETAILED DESCRIPTION OF THE PREFERRED EMBODIMENT

Described herein is chronic illness management system that uses predictive analytics to enable case managers to virtually support and manage behavioral health patient populations and coordinate collaborative care (also called integrative care). The system according to the present invention is multi-platform, cost-effective, scalable, and HIPAA compliant, it provides a way to facilitate connections and communications between a patient's PCPs and behavior health providers using virtual case-managers, and to provide 24/7 case management assistance to patients using a team of case managers, or “care managers”, centered around the patient's individual selected care manager.

The behavioral case management method according to the present invention may be implemented in a data processing network comprising two or more remote workstations, such as a personal computer, mobile phone, tablet, or the like, at least one application server and at least one secure, HIPPA-compliant database management system, all connected over one or more communications networks enabling the transmission of both data and voice phone calls. In preferred embodiments, the system includes HIPPA-compliant features such as SFTP encryption to the secure servers with whitelisted IP addresses for each user, including client, care manager, health care providers and other privileged parties, STTPS encryption from the secure servers to remote workstations, and restricted access for server administrators to limit their ability to see and/or write all client data in the secure database. In certain embodiments, the data processing network on which the present invention is implemented involves at least one land-line telephone and at least one facsimile machine.

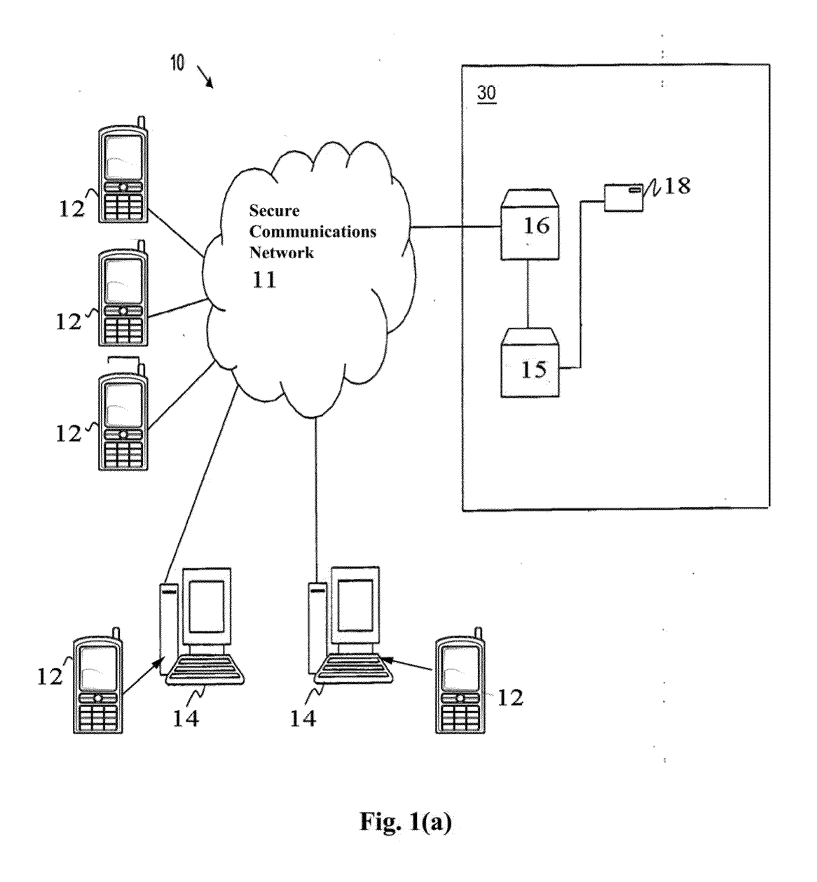

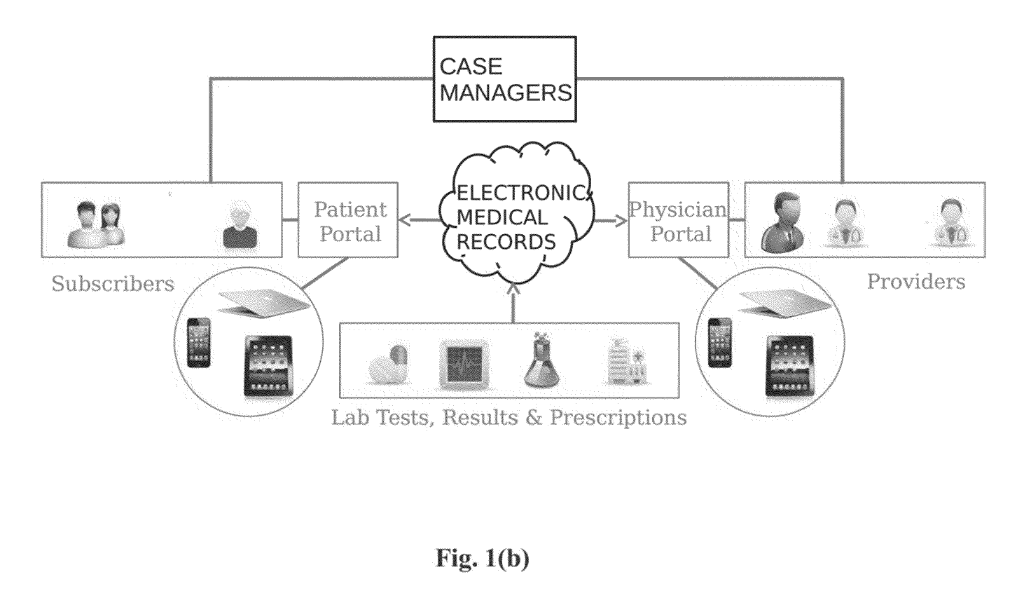

FIG. 1(a) is an illustration of the preferred client-server hardware architecture according to the present invention. The remote workstations accessible by client, care manager, health care provider, and other privileged party are represented by reference characters 14 and 12 (for mobile devices), and may be any text-messaging capable device including POS, POI, PDAs, cell phones and the like, or laptop/stationery personal computers having a native text-messaging application. Groups of remote workstations 14, 12 are connected to the Mindoula network 30 via an secure communications network 11 providing SFTP and HTTPS encryption capabilities. The secure Mindoula network 30 includes a web-enabled server 15 hosting a resident routing database 16, which stores data authentication and verification information (usernames and passwords) correlating to registered participants. Network-enabled server 15 hosting a resident routing database 16 also provides a secure gateway which ensures security of data as well as operating compatibility between the secure Mindoula network 30 and the secure communications network 11.

A secure database 18 comprises a database server running database management software to provide database services to secure Mindoula network 30. Database management systems frequently provide database server functionality, and some DBMSs (e.g., MySQL) rely exclusively on the client-server model for database access. Thus, secure database 18 preferably hosts a network database, preferably an SQL server database, running MySQL (a popular open source database). Other examples of suitable database servers are Oracle™, DB2™, Informix™, Ingres™, and SQL Server™.

The secure gateway in routing database 16 may be a Citrix Access Gateway®, or other suitable secure data access solution that provides administrators with software and data-level control while providing other privileged parties with remote access via remote workstations 14 and mobile devices 12 for securing the delivery of data to secure database 18.

The inventive method involves the interactive generation and compilation of a Discovery Assessment, described in greater detail below, between the system, referred to herein as the “Mindoula® system” and the client via a remote workstation, which Discovery Assessment is then transmitted by the client's remote workstation to the Mindoula system's secure. HIPPA-compliant database for storage and password-protected access by the care manager and other authorized parties, as will be described. Herein, the term “client” will be used to refer to an individual suffering from a metal health issue and who interacts with the Mindoula system via one or more remote workstations as described above. The Mindoula system also enables selection of an individual care manager for each client, and sets up an account, or discrete storage location behind a firewall within the Mindoula system's database, for each client, accessible only by the client, his or her care manager, and other privileged parties as defined below via individual usemame and password protection. As used herein, the term “care manager” refers to an individual trained in mental health case management who interacts with the system through one or more remote workstations, also as described above. Thereafter, the system generates and transmits check-in or “condition” requests, at regular intervals, to the client, receives data in response thereto, and stores the received data in the secure database.

The Mindoula system also tracks and logs data received from other parties with access to the system, such as one or more care managers, providers, psychiatrists, medical or laboratory facilities, system administrators and/or others to which one of these parties grants access, such as a hospital administrator or friend or family member of the client. As used here, the term “provider” may refer to any medical doctor, psychiatrist, psychologist, nurse, or other behavioral health professional that treats or reviews the files of the one or more clients utilizing the Mindoula system. Each party with access to the Mindoula system is herein referred to as a “privileged party”, wherein any given privileged party may have access to one or more individual client accounts. In addition, in preferred embodiments of the disclosed invention, the Mindoula system the care manager or a Mindoula system administrator may grant, or deny permissions to individual privileged parties to see one or more categories of data housed on the secure database by configuring firewalls to protect the portion of the database where the protected data is stored, and allowing passwords belonging to one or more of the privileged parties to have access to the protected data behind the firewall, based on design preference.

In response to each receipt of data from one of the privileged parties to an individual user's account, the Mindoula system logs this additional data in the individual client's account portion of the Mindoula secure database for use by the client's care manager(s), providers, the client him or herself, and the Mindoula system for incorporation into future treatment assessments and decision making processes.

In another embodiment of the present invention, the system may additionally employ a referral database and method to facilitate referrals and appointments for the client to and with additional providers. In yet another embodiment of the present invention, the system generates an interface, accessible to the client and other privileged parties via remote workstations over a communications network, through which the client and other privileged party can access relevant content, including but not limited to videos and/or articles of interest, in the Mindoula system's database. In other embodiments of the present invention, individual features of the invention as described may be used as discrete products by the client based on his or her individual needs.

In all the method according to the present invention, as enabled and facilitated by the disclosed system, allows the coordination of care for the client, by the care provider and the Mindoula system, between all or a plurality of the client's providers; coordination of referrals of the client to additional providers; coordination of medication prescription and monitoring for the client; and routine communication between the client and the care provider and monitoring by the Mindoula system, on behalf of the care provider, of the client's mental state, sleep and activity levels in real time on a routine basis. One, some, or all of these features may be made available as a product package to a given client based on his or her individual needs as determined by the client and/or by the Discovery Assessment. Individual features of the present invention will now be described in detail with reference to the accompanying drawings.

Discovery Assessment

The Discovery Assessment process results in the generation of a report stored on the database of the Mindoula system and accessible by the case manager and certain other privileged parties, that provides a robust picture of the client's symptoms, behaviors, and functioning in key domains including: depression, anxiety, trauma exposure, PTSD, bipolar disorder, psychosis, alcohol use, drug use, suicide, sleep, physical functioning and social functioning. The method proceeds in two phases. In the first phase, the client is presented with a series of questions via a visual display on his or her remote workstation. The questions presented to the client are selected by the Mindoula system from a grouping of questions in the secure database of the Mindoula system, transmitted from the Mindoula application server to the client's remote workstation via the communications network and displayed on the display of the client's remote workstation. The display generated for each question and appearing on the client's remote workstation includes a series of radio buttons or checkboxes next to each of a series of potential answers to the selected question. The client may choose one of the pre-populated answers to the posed question, or, alternatively, the Mindoula system may allow, in the case of some or all of the questions posed, for the client to write in an answer in a provided blank space. The data generated by the client's choice in answer is transmitted from the client's workstation to the Mindoula system's database via the communications network for storage in the client's account. Each client utilizing this portion of the Mindoula system's service completes this first phase of the Discovery Assessment in the same fashion.

In the second phase of the Discovery Assessment, the client is presented with a series of questions in the same manner, however the Mindoula system selects the questions presented to each individual client, in the second phase based on his or her answers in response to the questions in the first phase of the Discovery Assessment. The questions posed during the second phase of the Discovery Assessment are chosen as more in-depth assessments of the client's condition based on issues identified by the client's answers to the questions posed during the first phase of the Discovery Assessment. The data generated by the client's answers to the questions posed in the second phase of the Discovery Assessment are transmitted in the same way to the Mindoula system for storage in the Mindoula system's secure database behind a password-protected firewall.

Questions chosen for both the first and second phases of the Discovery Assessment are chosen based on their clinical utility in planning interventions of the type achieved by the Mindoula system as described in further detail below. For example, questions chosen for either the first or second phases of the Discovery Assessment are may be based on one or more of the following psychological assessments: the M3 Assessment (depression, anxiety, sleep disturbance, bipolar disorder and/or PTSD); MCBHP trauma screen (trauma exposure); M3+PHQ-9 (suicidal ideation); MCBHP (psychosis); NIDA quick screen (alcohol and/or drug use); PROMIS (physical or social functioning, sleep disturbance); PCL-5 (PTSD); SBQ-R (suicidal ideation); MDQ (bipolar disorder); Yale PRIME (psychosis); AUDIT-10 (alcohol use); and/or DAST-10 (drug use). The cumulative data generated by the client's answers to the questions posed during the first and second phases of the Discovery Assessment are compiled into a report generated by the Mindoula system for use by, preferably, the care manager and/or one or more psychiatrists engaged by the care manager via the Mindoula system, but additionally the client and other privileged parties based on design preference, in treating the client. The report preferably includes the client's basic physical, condition, the M3 overall score, the four M3 sub scores (depression, anxiety, bipolar and PTSD) and scores for each of the in-depth assessments taken by the client during the second phase of the Discovery Assessment. The Discovery Assessment report preferably also includes a scale for each based on the average/range/other measure of the client's scores compared to other potential clients or persons suffering from a mental health issue. The report preferably also includes each question and the corresponding answer provided by the client, for each phase of the Discovery Assessment.

The screening instruments will be used to identify symptoms, behaviors, and deficits in functioning that will then serve as targets of intervention for the Mindoula Intervention, to be described in greater detail below, which may include specific interventions, goal setting, and/or referral to other providers or services.

In addition to prompting the client to answer the questions contained in the screening instruments, the Mindoula system may also prompt the client, via a text request displayed on the user's remote workstation, to provide all or selected portions of his or her own medical records. In a preferred embodiment, the system displays an interface in which the steps for transmitting data from the client's remote workstation to the Mindoula system's database are provided and/or interactively conveyed. The Mindoula system may be configured to accept data transmitted via the communications network from the client's remote workstation (such as, i.e., documents in PDF format) or via any alternate communications network such as a fax line. In an alternate embodiment, the client's completion of the Discovery Assessment will prompt the Mindoula system to send a medical records transmission request to one or more of the client's current or past healthcare providers. Client medical records received from any source are stored in the secure Mindoula system database behind an appropriate password-protected firewall.

In some embodiments, the Mindoula system software asks the clients for characteristics they are looking for in a care manager. The software provides a list of candidates to the client based on these characteristics, and the patient selects a care manager. The system may populate a list of care managers, stored in the Mindoula database, and the clients associated with each care manager, for reference by privileged parties. The system may also implement a set of rules, alterable by design choice, that limits the maximum amount or type of clients that may be assigned to a given care manager, such as by removing the care manager from the list of available care managers presented to new clients until the number or type of clients assigned to that care manager changes to bring these metrics within tolerable limits. In a preferred embodiment, the system may assign to the client, based on his other “primary” care manager selection, an additional “team” of care managers to enable the care manager team to provide full coverage, 24/7, of support to the client. In another embodiment, the client may select his or her own team of care managers given the set of matching or other rules provided to the system. Also in a preferred embodiment, a care manager “team” may include one or more Mindoula administrators or member support people to assist both the client and the care manager team by providing administrative functions.

In some embodiments, the client is also required to complete a physical health assessment, consisting of a plurality of questions regarding the client's physical state and current physical health, in the same manner as he or she has completed the Discovery Assessment. The Discovery Assessment may also include the collection of assessments made by individual treatment providers for the client, which may be existing treatment providers and/or providers to which some or all of the Assessment data is transmitted by the system for independent review of same.

Finally, the system prompts the client for payment information, which is also secured in a secure location within the Mindoula database. The Mindoula system preferably includes communication means for transmitting the provided payment information to a payment processing system for processing the client's provided payment information and generating funds transfer requests to transfer the required payment from the client's account to an account accessible by administrators of the Mindoula system by methods known in the art.

All data collected by the Mindoula system from the client, his or her providers, and/or other sources during the Discovery Assessment are stored in the Mindoula system database in a secure location and in a means by which they can be identified with the relevant client's account. In addition, when the Discovery Assessment (including optional physical health assessment data) is completed, the Mindoula system generates a report, as described above, summarizing the Assessment and conclusions that may be drawn therefrom. The report is stored in the Mindoula database accessible by the care manager(s) and other privileged parties. In a preferred embodiment, the Mindoula system also transmits, to the remote workstation of the client's chosen care manager via the communications network, a message to one or more of the client's providers, as well as the client's chosen care manager, providing a link and secure sign-in to access the report, along with identifying information for the client to which it pertains. Also in a preferred embodiment, the system transmits a signal to the care manager's remote workstation, which signal causes an alert to appear on one or more of the chosen care manager's remote workstations. Said alert may be in the form of an audio or visual alert, such as a “pop-up notification”, to alert the chosen care manager that he or she has been selected to be the care manager for the new client and requesting his or her review of the new client's Discovery Assessment.

In this way, treatment providers and the client's selected care manager(s) may access the client's account to obtain a lull medical overview of the client and his or her physical and/or mental health condition(s) at the outset of his or her interaction with the Mindoula system, and to act on that information in assisting the client through the treatment process. In addition, in a preferred embodiment, as described below with respect to the Mindoula Intervention and the Mobile Engagement Application, additional data generated by successive treatments, therapies and/or status updates from the client him or herself may be uploaded into the client's personal Discovery Assessment in real time, and the treatment process suggested by the Mindoula system altered based on the observed results of the provided treatment, all of which are reported to the Mindoula system and stored in the system's database. In addition to improving treatment outcomes, this process results in the generation of a large database of evidence tending to show which treatments are effective and which are ineffective, along with relative levels of effectiveness, of various treatments or Interventions based on the clients' self-reported status and baseline(s) and periodic updates provided by treatment providers and care managers as described herein.

The Mindoula Intervention

In addition to the initial, “baseline” data stored in the Mindoula database at the conclusion of the Discovery Assessment process, additional data is collected by the system during the client's engagement with the system. Treatment recommendations generated by the Mindoula system may be revised based on this incoming data from one or more, but preferably all, of the clients that share treatment data with the Mindoula system. In a preferred embodiment, treatment recommendations may be generated by the system based on inputs to the database generated by the client, care manager, the client's friends, family, treating physicians, etc. In other embodiments, a treatment provider or care manager may choose a treatment option for the client based on his or her own experience in combination with the data in the client's Discovery Assessment as housed in the Mindoula database. After a given treatment is administered to the client, the treatment provider may generate a report of the treatment provided for upload to the Mindoula database. Alternatively, in the case of any treatment suggested by the Mindoula system, the system may prompt the treatment provider and/or care manager, via prompts on his or her remote workstation sent by the Mindoula system over the communications network, to indicate “YES” or “NO” as to whether the suggested treatment was provided and/or to input data into the system indicating the method, time period, and other parameters over which the treatment was carried out. When a treatment protocol for a given client is entered into the Mindoula system, the system may thereafter generate, at predetermined intervals, a request to the treatment provider and/or care manager, via his or her remote workstation, to input updates of the client's progress through treatment for storage in the client's account in the database and updating of the client's Discovery Assessment.

The Mindoula Intervention process utilizes predictive analytics, using the trait and state assessments provided by the Discovery Assessment, weighted measures of the check-in data, as described in more detail below, words, and word patterns used in open-ended communications (e.g. general negativity in language, expletives, increased use of the word “I”, language pattern changes, for voice communication changes in speed, energy, and inflection, etc.), and usage patterns (e.g. frequency of patient check-ins and patient need requests), to inform case management. The system described herein aggregates, encrypts, and anonymizes patient data and then runs that data through data analytics tools to provide actionable data (including risk factor identification) to guide evidence-based care manager interventions relating to underlying chronic illness—driving improved outcomes.

A few examples of possible Mindoula intervention scenarios are described below:

(1) Depression

For patients experiencing depression, the system can recommend and/or care manager can initiate behavioral activation. Behavioral activation is an evidence based component of cognitive behavioral therapy. A typical depressed patient does very little and because of that he encounters very limited reinforcement. A lack of reinforcement leads him to feel worse which in turn leads him to do less. This becomes a vicious, self-promulgating cycle. In contrast, behavioral activation focuses on increasing the amount of reinforcement that the patient experiences by scheduling pleasant and mastery related activities. Behavioral activation includes a strong component of psycho-education regarding the role of behavior in maintaining depression and the importance of acting according to the plan versus acting according to mood.

(2) Sleep Problems

For patients reporting sleep problems, the system can recommend and/or care manager can initiate working with the client on assessing and improving sleep hygiene. It is common for individuals with insomnia to also report very poor sleep hygiene (i.e., eating before bed, taking naps, getting up at different times of day). Addressing these behaviors can be very helpful in improving sleep.

(3) Low Social Functioning

For patients reporting low social functioning, the system/care manager can develop specific goals around social interactions. This can be at a level of basic social skills (e.g., work on maintaining eye contact when someone is speaking to you) or at the level of building a social network (e.g., attend one new social even per week).

(4) Bipolar Disorders or Psychosis

The system can recommend and/or the care manager can implement referring the client to a psychiatrist. Referrals and or other medication prescriptions or adjustments may be enabled by the system via the Collaborative Care Platform and/or Referral Database as described in more detail below.

Mobile Engagement Application

The Mobile Engagement Application (“Application”) enables both predefined client check-ins on a numeric rating scale for metrics such as mood, energy level, stress level, etc., and open-ended phone, text, and email communication between the client and his or her chosen care manager(s). As such, the Application serves as yet another means of collecting data for transmittal to and storage in the Mindoula system database for updating of the client's Discovery Assessment. In addition, the Application allows the client's care manager to see, directly on his or her own mobile device, the client's current mental and physical status and history of mental and physical statuses, referred to herein as “check-ins.” In addition the Application allows voice communication between client and care manager and between the client and emergency dispatch services (9-1-1), and provides alerts to the client and care manager when communication is desired or when the client has called for emergency services. The Application also provides an at-a-glance history of these actions. Thus, the Application provides a means of personal communication when necessary between client and care manager to effectuate the client's care management. The system and method include attention bias modification training by diverting focus of members to platform activity (e.g. earning points & rewards) vs. focus on perceived threatening stimuli. The end result is a technology that helps reprogram patient processing of environmental stimuli and their behavioral response to such stimuli.

The Application may be used by some clients of the system, but not others, depending on the individual client's needs and diagnosis/Assessment. The Application is preferably accessible only by the individual privileged member on whose device the Application has been downloaded via personal username and password provision.

The Application operates on a system as described above wherein at least two remote workstations are data and voice-enabled mobile devices of the client and care manager, having both text message and call capabilities. The Application may consist of an interface that is downloaded directly onto both the client's and care manager's mobile device and accesses the calling and text messaging functions of the respective mobile devices. In a preferred embodiment, the system sends a prompt to the client's remote workstation requesting the client to download the app to his or her mobile device after the client's completion of his or her Discovery Assessment. In other embodiments, the care manager or a provider may request the system to send a request to prompt the client to download the Application based on an assessment that the client needs individualized, one-on-one care from a care manager in the form of direct contact and 24/7 access to his or her care manager as provided by the Application. In yet another embodiment, the Application may be downloaded by a client without completing a Discovery Assessment based on authorization from a care manager or other system administrator.

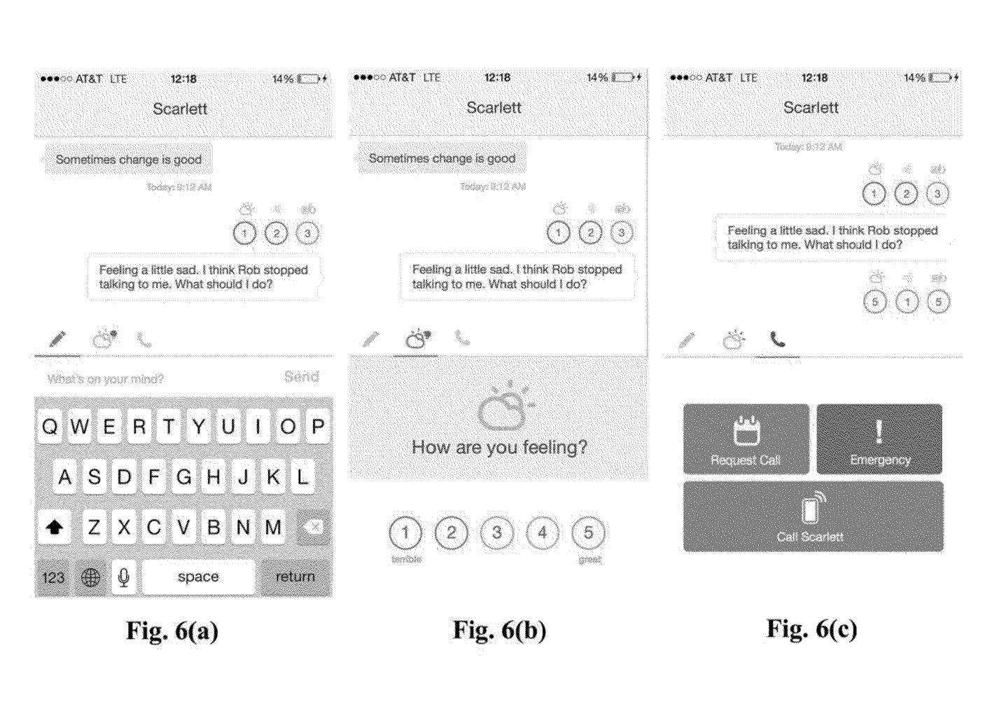

The Application may further consist of a client-side interface and a care manager-side interface, each having separate capabilities. Representative client-side Application interfaces are shown in FIGS. 6(a)-(c), Upon launching the client-side interface, the client is presented with a series of options. As shown in FIG. 6(a) the client may select a chat function through which he or she may chat directly with his or her care manager. The chat function is preferably password protected, such that any user must log in with a username and password. Data generated via the chat function, as well as all data generated in the Mobile Engagement Application, is preferably encrypted prior to transmission on the Mindoula system network. The network used by the Mindoula system preferably utilizes an AWS communications spectrum or the like. Chat data may be transferred from client to case manager and vice versa via the Application and displayed in the respective mobile device Application interfaces. In a preferred embodiment, all data generated through the Application is also transmitted, to the Mindoula database for secure storage in the client's account in connection with, or as an update to, his or her Discovery Assessment.

FIG. 6(b) illustrates yet another function of the Application. On the client-side interface, the client is presented with an option to input status updates or “check-in” reports which may be viewed and tracked by his or her care manager in real-time on a 24/7 basis. Upon selection of this function via the slider button as shown in FIG. 6(b), the client is presented, with a series of questions to judge his or her current mental and/or physical condition and status. Possible questions may include: “How are you feeling?”; “How are you sleeping?”; “Are you getting stuff done?”; etc. Additional questions may be presented to the client based on design preference, i.e. to generate measurements of client mood measurements or levels of anxiety, depression, etc. The client may choose to answer one, all, or none of the questions presented, and may choose to repeat answers to one or more of the questions presented as many times as desired, by clicking on one of the numbers in a scale of (1)-(5) presented at the bottom of the client-side Application interface when the check-in function is activated. The numbers in the scale correspond to degrees of agreement or disagreement with the question posed or to a value in a range of possible answers, such as: “I'm feeling great” or “I'm feeling terrible.” Each such response given by the client within the check-in function of the Application is transmitted to the client's care manager and logged in both the client's and care manager's Application as a check-in history as shown in FIG. 6(b). The check-in data generated by the client is visually integrated into the overall Mobile Engagement Application interface on both client and care manager side, enabling both to see a timeline, in real time, of the client's check-in reports combined and integrated with any text chats exchanged between care manager and client so that both parties and others able to access said data may have a clear and full picture and timeline of the client's status and interactions with his or her care manager. In a preferred embodiment, as stated above, the client's responses are also logged in the Mindoula database in association with his or her individual account and Discovery Assessment. Completion of “check-ins” by the client, or adherence to a predetermined check-in “schedule”, may generate “points” stored in the database that may be accumulated by the client and used to obtain various rewards in exchange for a predetermined number of points.

In another preferred embodiment, the questions presented to the client via the check-in function may evolve based on the feedback that the client provides to previous check-in questions, system analysis prior text message communications between client and care manager, such as via word recognition and association, based on his or her Discovery Assessment, inputs generated by his or her care manager, and/or other treatment data input into the system. In this way, the check-in function may provide a sort of “smart” interface to better gauge the current status and needs of the client in a real-time, 24/7 basis, and to potentially supplant some of the functions of the care manager in providing 24/7 support and engagement services for the client.

A third function of the Application, the call function, is shown with reference to FIG. 6(c), When this function is selected on the client-side interface of the Application, the client is presented with options to “Request Call” from his or her care manager, “Call ______” (where the name of the client's case manager may be filled in), or “Emergency.” Selecting the “Request Call” button will send a prompt to the client's care manager, via the care manager's mobile device, to call the client. Selecting the “Call ______” button will result in the Application accessing the telephone function of the user's mobile device to place a phone call to the client's care manager. The care manager's preferred phone number or numbers may be programmed directly into the contacts section of the client's mobile device or may be stored within the Application itself. Selecting the “Emergency” button will result in the Application accessing the telephone function of the user's mobile device to place a phone call to emergency services (9-1-1), and a prompt to the client's care manager to inform him or her that the client has just attempted a 9-1-1 phone call. Again, all data generated by the Application is preferably also transmitted to and stored in the client's account in the Mindoula database.

Additional features of the client-side interlace of the Application may include means to view and/or edit his or her medical records or profile as stored in the Mindoula database in his or her personal account. Such information may include the user's current medications, diagnosis, allergies, insurance information, emergency contacts, basic profile data, and/or other data contained in the client's profile in the database. The Application may thus provide an interface through which the client may transmit requests over the communications network to the Mindoula application server to request that the server transmit certain elements of the data housed on the Mindoula database to the client's remote workstation/mobile device. Alternatively, such information may be housed locally on the client's mobile device. The care manager-side interface of the Application may have a similar function.

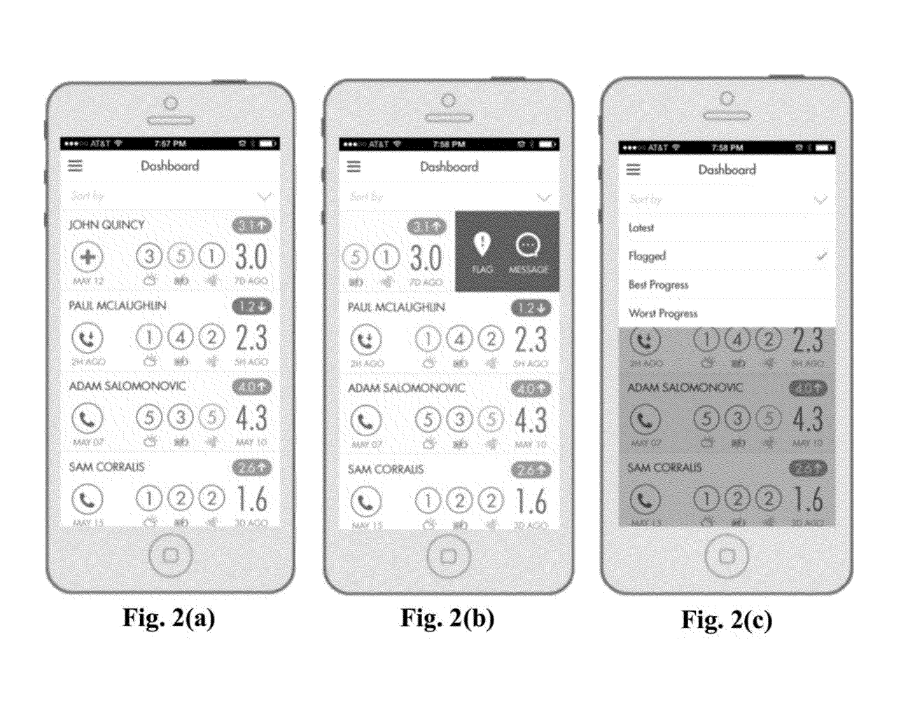

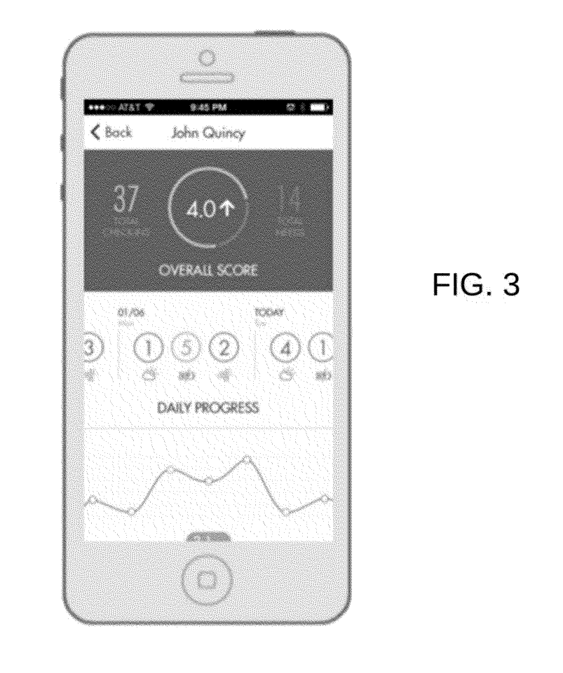

The care manager-side interface of the Application allows the care manager to view data generated his or her one or more clients, to communicate with his or her one or more clients, and to input data related to one or more of his or her clients, such as by “flagging” one or more clients with one or more current statuses. FIGS. 2(a)-(b) and 3 show sample care manager-side interfaces. As shown in FIG. 2(a), the Application's care manager-side interface allows the care manager to view his or her clients in a list alongside the client's most recent status and/or average of the statuses of a past given period of time such as the past day, and/or the change in the client's status on average over a past given period of time such as the past day. Different “weights” may be assigned to different types of check-ins (i.e., more weight may be assigned to the answer to the question “How are you doing?” when calculating an average client status). The care manager-side interface may include different measures of client wellness pulled from different metrics, or types of questions, presented to and answered by the client. Changes in this data, may be color-coded or represented by one or more symbols, chosen as a matter of design preference, to indicate to the care manager at a glance how the client's treatment, attitude, activity level and well-being has been progressing, and/or compiled into different statistics for the generation of patterns reviewable by the care manager and/or other treatment providers. The care manager-side interface may also include an indication of the amount of time since the client provided the most recent data that appears on the care manager's Application interface. Data may be presented in a week-to-week and/or day-to-day comparison of previous client check-ins for viewing by the care manager. The listing of clients may be sorted by client status (best to worst or vice versa), the client's condition, time since last check-in, “flag” status, alphabetical order of the client's name, etc. as shown in FIG. 2(c).

As shown in FIG. 2(b), the care manager may “flag” one or more clients as possessing a certain condition or to indicate that extra-Application action is needed to farther the client's care. Flag “states”, alterable according to design preference, may include: “none”, “moderate”, “serious” and/or “suicide risk.” In addition, the Application may provide a means for the care manager to call or send a text message to a chosen client by accessing the address book, SMS text function or telephone functions of the care manager's mobile device.

The Application may further provide a means for the care manager to view additional details related to each of his or her clients, such as all data associated with a given client's account and/or the client's history of data submission in the form of “check-ins” or otherwise. The care manager-side interface of the Application may additionally include a graphing feature through which the care manager may view statistics, and change in values, associated with each of his or her clients over a given period of time.

Further, it will be understood that more than one care manager may care for a given client in order to provide the client with 24/7 access to care as needed. Therefore, a given client may appear in the client listing in the care manager-side interface of the Application for multiple care managers, and a client may have the option to text, call, or otherwise provide data to one or more care managers from the client-side interlace.

Referral Database

The Referral Database may represent a portion of the Mindoula database in which data associated with mental health providers may be stored. The Collaborative Care Platform, described in further detail below, manages referrals, provides continued care manager contact with the client and monitors the outside referrals (psychiatrists, therapists, physicians) or treatment programs that are most effective. The most effective (data driven) treatment protocols are used in similar clients who are similarly unresponsive to attempted treatment protocols.

The Collaborative Care Platform provides for regular reassessment to track patient progress and continually improve the Discovery Assessment described above. When clients are not responding to the determined treatment protocol for them, they can be referred outside the system for more individualized care. Providers to which referrals are possible via the Collaborative Care Platform may be housed in the Referral Database. If referred to a non-Platform provider, data from the resultant treatment may be manually recorded in the Mindoula database.

When a referral is made to a provider that does not have access to the Collaborative Care Platform, the system may prompt the client to fill out and sign release forms as necessary under HIPPA to allow the Mindoula system and care managers) to view the health data generated by the client's visit to this additional specialist. Alternatively, the system may prompt the care manager to prepare these forms on behalf of the client and obtain the required signatures on same, and then to transmit the completed forms to he stored in the client's account on the secure database. Additionally, means and/or legal release forms may be provided to permit the outside care provider to upload health data and notes pertaining to the client's care directly to the system, such as through a Collaborative Care Platform interface or by coordination with the care manager. Alternatively, the care manager may undertake the task of collecting health care data directly from the outside provider and providing it to the database. The system may assist the care manager in this role by providing updates and reminders of upcoming appointments, treatments, medication changes, benchmarks, and/or reminders to check on the status of the client's outside care at regular intervals, similarly to those provided to the care manager for treatments provided by the client's primary treatment providers. In the case where health data is uploaded to the system by a party other than the care manager, the system will transmit an alert to the care manager via the Collaborative Care Platform or Mobile Engagement Application. Such an alert may be in the form of a HIPPA-compliant email (i.e., not containing any protected health information in the body of the email) sent to one or more parties. The care manager will be able to review all of the client's health care data, including that generated by outside appointments and treatments, via the Collaborative Care Platform as described below.

Collaborative Care Platform

The Collaborative Care Platform (CCP) enables virtual engagement principally between the client's care manager and primary treatment provider (or primary care physician (PCP)) for purposes of coordinating treatment for the client. In some embodiments, required treatment may be indicated by the client's Discovery Assessment and according to the system- or care manager-determined Mindoula Intervention. FIG. 1(b) shows a general outline of the system organization of the present invention.

The CCP may be utilized by clients In different ways based on each client's individual needs. In some embodiments, the CCP facilitates the coordination of client care by managing medication prescription/refill/alteration, appointment creation and reminders, and exchange of health records among treating physicians. In other embodiments, the CCP may additionally, or alternatively, allow for population management by the care managers via the Mobile Engagement Application Described above. In the latter case, the CCP may provide alerts to the care manager at various intervals corresponding to virtual interventions needed to be undertaken by the care manager on behalf of the client. These may include one or more of the Mindoula Interventions as described above, contacting a client's provider, friend or family member, scheduling a healthcare appointment for the client, monitoring prescription refill levels, etc. Such intervention may be achieved by the care manager through personal, virtual contact with the client via text of phone conversations on the Mobile Engagement Application. In addition, as described above, all data generated via the Application is preferably transmitted back to the CCP for inclusion in the client's account in the Mindoula database. In addition, the CCP prompts providers, via a reminder on his or her remote workstation sent via the communications network, to indicate whether or not the treatment has taken place, and the CCP includes this data in the client's account. Notes generated during the treatment by the provider, care manager and/or client may also be transmitted directly back to the CCP for storage in the Mindoula database via the provider/care manager/client interface of the CCP as described in greater detail below.

In a preferred embodiment, upon completion of the client's Discovery Assessment and creation of the client's account, the Discovery Assessment is transmitted by the system via the communications network to a third party provider, preferably a psychiatrist, for review and assessment via his or her remote workstation. Thereafter, recommended treatment for the client can be input into the CCP, which may then generate reminders to be sent to the care manager and/or client pertaining to various goals along the treatment plan, such as the scheduling of appointments with providers, check-ins with the client, alteration of medication, medication frequency or medication dose to correspond to one or more trial periods to ascertain the appropriate medication for a given client. Alerts programmed into the CCP may also trigger the CCP to access a provider appointment calendar, such as an appointment calendar accessible via the Internet, to generate an appointment for the client within one or more predetermined time periods (entered into the system by the client/care manager/etc.) as the provider's availability allows. Alerts may also trigger the CCP to send notes, updates, prescriptions, etc. to various parties accessible over the network such as doctors' offices and pharmacies. In addition, all such data corresponding to the client's treatment is stored in the client's account in the Mindoula database and tracked by the system for viewing by the client, care manager, and/or other privileged member.

The CCP also contains a visual calendar accessible by all parties with access to this data, on which events such as health care appointments, medication changes, and the like are listed in a calendar view. The CCP calendar may be programmed to provide alerts, via email or notifications through the CCP interface, to some or all parties upon the happening of certain calendar events.

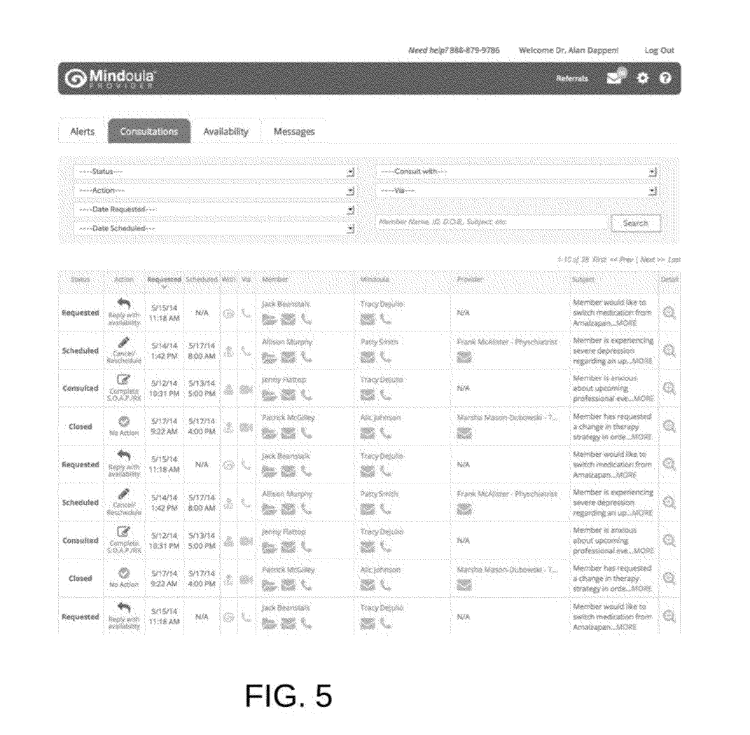

FIG. 5 shows one view of the provider portal that enables collaborative care according to one embodiment of the CCP, where the care manager has scheduled consultations with providers regarding various clients' needs. This system portal gives provider access to a list of clients with information about each client and their status readily available to the provider. The clients can be selected for more detailed information. An alert or icon, or the placement of the client on the list, is determined by software analytics, where information, pulled from the client's account, such as flags placed on the client by the care manager via the Mobile Engagement Application, may contribute to the generation of an alert or icon. In addition, the software according to the present invention can scan messages (either text or transcribed voice messages) collected by the database for indicators of acute mental problems. The regeneration of the Discovery Assessment after collection of updated information regarding the client's medical, history, state and trait assessments, asynchronous and synchronous data and communications may generate an alert if an intervention, such as an appointment or medication change, is needed. An alert, may also be generated by the system via the CCP if health care data is uploaded to the client's account in the database by any party. Such an alert may be in the form of a HIPPA-compliant email (i.e., not containing any protected health information in the body of the email) sent to one or more parties.

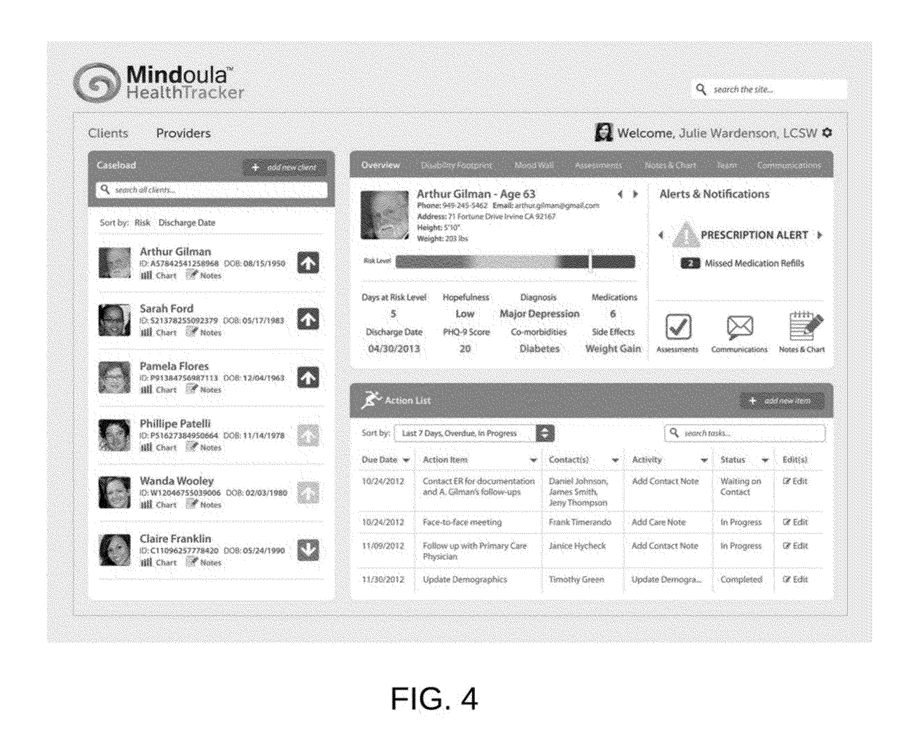

The CCP also provides a care manager portal (shown in FIG. 4) through which a care manager may review the status of and all data connected with each of his or her clients. The CCP care manager interface is also where the care manager may receive notifications for various elements of care or action items that need to be undertaken on behalf of the client. The care manager portal may also provide a list of suggested providers for the care manager's use in engaging additional providers to care for one or more clients.

The CCP also provides a client portal. The client portal is accessible 24/7 and may also provide client access to tailored and engaging educational material relevant to the individual

client. In preferred embodiments, this software provides reminders to clients to engage in various action items that improve mental health such as: taking medication, walking, checking in with their doctor, providing their mood check-in, and showering. The CCP may also provide reward points for successful completion of these action items. The reward points may be exchangeable for items of value such as gift cards. This system may operate in a manner similar to the operation of point collection for client check-ins In the Mobile Engagement Application described above.

The CCP may also provide interfaces, accessible via one or more remote workstations over the communications network, for several additional members of the mental health system, including: the client's family, psychiatrist, primary care physician, pharmacist and other specialists, and other behavioral health clinicians. Various elements of the data described above with respect to client, care manager, and/or provider portals may be accessible to additional privileged members via these alternate interfaces. The system may present clients, their care managers and/or the system administrator(s) with options for differing degrees of access to be made available to additional privileged parties based on their role(s) in the care of the client, other than the client, care manager, and treatment providers themselves, such as friends and family members of the client.

Thus, psychiatrists, therapists, and primary care providers can log in to their respective interfaces and access information about their shared client and communicate in a HIPPA compliant environment. In this way, the inventive system accounts for what would otherwise be fractured care by allowing providers who work with the same member, but in different settings to coordinate their care. The CCP may also provide a collaboration platform for group conferencing, shared electronic medical records, scheduling, progress tracking, and action items. It may also allow providers a means to contact specialists in other areas and schedule consultation, and provide an in-application calendar of appointments for the providers. It also allows care managers to contact primary care physicians and behavior health providers with patient needs.

Additional preferred implementations of the system and methods according to the present invention are described below.

The comprehensive case management level of service targets clients with SMI. The service level focuses on clients with primary mental illness who are being discharged from the hospital or long-term residential facilities as well as clients with SMI who are identified in primary care and other treatment settings. For hospitals, the primary goal of comprehensive case management is to prevent hospital admission or readmission. For long-term residential treatment facilities, the primary goal is to preserve the outcomes gained in long-term residential care. This is achieved in a comprehensive manner, by, among other things, providing linkages to psychiatric care and other services and specific interventions targeting increased functioning

Comprehensive case management includes 24/7 support, including in-person case management visits as necessary. The primary cafe manager coordinates care and serves as a central point of contact for all of the client's care providers including the primary care physician, psychiatrist, therapist, pharmacist, and other health specialists. In addition, the care manager works closely with the client's family members and other close contacts to best address the needs of the client. The care manager provides important support and assistance to the client, with a focus on integration into the community, achieving educational goals, obtaining and sustaining work, and helping with tasks of daily living. While much of this work is achieved virtually, comprehensive case management sometimes includes face-to-face meetings and home or dorm visits. The primary care manager is responsible for most client contact, and a back-up team of care managers provides secondary and tertiary support to facilitate around-the-clock case management. The back-up team has access to important information about each client that is available via the CCP and/or Mobile Engagement Application depending on the individual client needs.

The collaborative care level of service targets clients with mental disorders (e.g., depression and anxiety) that are commonly seen in primary care settings. This level of care functions as an overlay to primary care in which care managers integrate psychiatric consultations into primary care via the CCP. Collaborative care is an evidence-based systematic approach to identifying and treating depression and anxiety disorders in primary care settings. Five core principles represent the foundation of collaborative care. The first of these is increased collaboration and coordination between all health professionals involved in the treatment of a client. Second, practices ascribing to collaborative care create and maintain a registry of all clients that fit the diagnostic criteria of the targeted disorder(s), typically depression and/or anxiety disorders. Third, clients have an individualized treatment plan with goals and targets that are regularly reviewed and altered as needed. Fourth, all treatments provided to clients have a solid evidence base to support their use. Finally, providers are accountable and reimbursed in accordance with client outcomes and quality of care, not just patient volume. Another key component of the collaborative care approach is the consistent use of standardized assessment measures of depression and anxiety, allowing for enhanced patient monitoring as well as coherent comparison and aggregation of patient outcomes. In collaborative care programs, a care manager, typically an allied health professional (e.g., nurse or social worker), performs many of the functions that the primary care providers do not have time to do. The care managers screen and evaluate patients, recommend care based on a client's evolving Discovery Assessment, and follow-up with clients regularly using objective assessments, once treatment is initiated. Rather than have a physically present care manager, the system according to the present invention can provide the services of the care manager remotely by overlaying its services on the primary care office, while still maintaining the active collaboration with the primary care team which is essential to in-person collaborative care. This creates efficiencies not available when a care manager has to be physically present on-site as a remote care manager can manage patients at multiple primary care offices simultaneously. This allows for different, payment models including fee for service and capitation by health plans.

In a preferred embodiment, a treatment method according to the present invention comprises completion of a Discovery Assessment, as described above, by a new client. Upon completion of the Discovery Assessment, the system prepares a report of same, which is stored in the secure database. The system then generates a HIPPA-compliant email to a consulting psychiatrist with access to the Mindoula system, such as via the Collaborative Care Platform, in which the consulting psychiatrist is provided with a link to download the client's Discovery Assessment for review. The consulting psychiatrist's notes upon review of the Discovery Assessment are transmitted and sent to the secure database. Additionally, treatment recommendations from the consulting psychiatrist may be uploaded to the database and/or calendared in the CCP calendar, with alerts. Upon the happening of each of these events, other parties such as the client, treating providers, and the care manager are sent alerts by the CCP to notify them of the progress of this method. In a preferred embodiment, the system, triggers the care manager to schedule a follow-up consultation with the client's primary treatment provider or PCP; alternatively, the system may automatically access the calendars of both parties and schedule such an appointment, with a reminder.

The system tracks all dates, times, and authors of any notes or changes made to the records in the secure database or calendar, and creates a change log that records every change to every record and the party who made the change. Notes, assessments, and test results cannot be overwritten in the system database.

Additional Applications

In addition to its use with SMI patients and as an overlay in primary care clinics for collaborative care, the system according to the present invention has application with other populations in need of case management. Like the programs described above, these programs will be tailored to meet the specific needs of the population. Examples include:

College Students

Building upon the communication framework, the disclosed system may provide 24/7 behavioral health support to college students facing behavioral health challenges, and establish linkages with college mental health services and non-profit organizations focusing upon behavioral health education and support for college students.

Employees

The disclosed system and method represents a useful adjunct or long-term referral source for Employee Assistance Programs. As EAP programs are typically time-limited in nature, they are often unable to meet the needs of employees requiring longer-term care.

Military Personnel

The disclosed system and method may be augmented to emphasize PTSD and traumatic brain injury diagnoses. Current behavioral health support for veterans and their families is inadequate to meet the need for services, and the current invention represents a promising intervention for this population. For active duty personnel, the current system and method represents a new way to address stress management and effective coping skills, and to target role transitions as soldiers return from deployments and resume life in the civilian world.

The above-described embodiment is for the purpose of promoting an understanding of the principles of the invention, it should nevertheless be understood that no limitation of the scope of the invention is thereby intended, such alternations and further modifications in the illustrated device, and such further applications of the principles of the invention as illustrated herein being contemplated as would normally occur to one skilled in the art to which the invention relates.

The system and method thereby improves behavioral health outcomes, and assists in detection, treatment, and prevention of chronic behavioral health illnesses. This regular check-in and caseload management functionality of the present system increases the efficiency with which a case manager can meet the needs of his/her members.

We claim:

1. In a data processing network comprising three or more remote workstations and at least one application computer server running software stored on non-transitory computer-readable storage medium for carrying out the steps according to the present method, and at least one secure, HIPPA-compliant database management system, said two or more remote workstations, at least one application computer server, and at least one secure, HIPPA-compliant database all being connected over one or more communications networks, a method of mental health case management, comprising the steps of:
administering, by said at least one application server via a first of said three or more remote workstations, a health assessment to a client;
providing, by said at least one application server via said communications network, results of said health assessment to a consulting psychiatrist via a second of said three or more remote workstations;
communicating, by said at least one application server via said communications network, a treatment plan generated by said consulting psychiatrist to a primary care physician for said client via a third of said three or more remote workstations;
storing said treatment plan in said HIPPA-compliant database management system;
collecting, by said at least one application server via said communications network, additional health data rewarding said client; and
storing said additional health data by said HIPPA-compliant database management system.

2. The method of claim 1, wherein said step of administering said health assessment comprises generating, by said at least one application server, a graphical user interface viewable on said one or more remote workstations.

3. The method of claim 2, wherein said graphical user interface comprises a first series of questions and a second series of questions and means to collect said results of said health assessment comprising data entered by said client in response to said first and second series of questions, wherein said second series of questions is generated based on the data collected by the at least one application server in response to said first series of questions.

4. The method of claim 3, wherein said questions assess both a mental and physical health of said client.

5. The method of claim 3, wherein said questions are chosen from a group consisting of the following assessments: M3 (depression), M3 (anxiety), M3 (PTSD), M3 (bipolar disorder), M3 (sleep disturbance), MCBHP trauma screen, PHQ-9 item 9, MCBHP psychosis screen, NIDA quick screen (alcohol use), NIDA quick screen (drug use), PROMIS-physical functioning, PROMIS (ability to participate in social roles and activities), PROMIS (social functioning long form), PROMIS (physical functioning long form), PROMIS (sleep), DAST-10, AUDIT-10, Yale PRIME, MDQ, SBQ-R, and PCL-5.

6. The method of claim 1, wherein said additional health data is selected from a group consisting of: physical health records, mental health records, assessments of said client by a care manager, assessments of said client by a treating party, and medication data.

7. The method of claim 1, further comprising storing, by said database management system, a list of specialty treatment providers.

8. The method of claim 7, further comprising storing, by said database management system, data related to treatments provided to said client by said specialty treatment provider.

9. The method of claim 1, further comprising the step of revising, by said at least one application server, said treatment plan based on said additional health data.

10. A method of treating a patient suffering from a mental illness, the method comprising the steps of:
providing a first phase self assessment to gauge the health of a client;
providing a second phase self assessment to gauge the health of said client, wherein said second phase self assessment is comprised of questions that are chosen based on responses given by said client to said first phase self assessment;
review said first and second phase self assessments with a consulting psychiatrist;
establish contact with a treatment team for said client;
establish a treatment plan based on said first and second phase self assessments;
establish a means of direct contact between said client and a care manager;
determine an interval for reassessment of said treatment plan;
reassess said treatment plan at said regular interval.

11. The method of claim 10, said method additionally comprising, prior to said step of establishing said treatment team, compiling said treatment team.

12. The method of claim 10, said method additionally comprising the step of establishing contact between said care manager and said client at regular intervals.

13. The method of claim 10, wherein said care manager may be one or more individual case managers.

14. The method of claim 10, further comprising the step of determining whether a referral to a specialty treatment provider is needed.

15. A system for providing virtual case management services for clients suffering from mental health issues, the system comprising:
two or more remote workstations, said remote workstations each comprising at least one graphical user interface and capable of transmitting data over a secure communications network;
at least one application server running software;
at least one secure, HIPPA-compliant database management system; and
one or more communications networks connecting said remote workstations, said at least one application server and said at least one secure database management system;
wherein said software is capable of compiling and storing, via said database management system, medical records pertaining to one or more of said clients, and of providing alerts to registered users of said system via said remote workstations when additional records are added to said database management system.

16. In a data processing network comprising two or more remote workstations, at least one application server running software for carrying out the steps according to the present method, and at least one secure, HIPPA-compliant database management system, all connected over one or more communications networks, a method of mental health case management, comprising the steps of:
administering, by said at least one application server via one of said at least one remote workstations, a health assessment to a client;
storing results of said health assessment by said HIPPA-compliant database management system;
generating, by said at least one application server for display on at least one remote workstation, a calendar containing dates corresponding to a treatment plan based on said results of said health assessment, said treatment plan comprising a series of planned events, said dates corresponding to a month, day, and year of each of said series of planned events in said treatment plan; and
transmitting, by said at least one application server to one or more of said remote workstations via said communications network, a signal in advance of each of said series of events, said signal comprising identifying information and month, day and year for said corresponding one of said series of events.

17. The method of claim 16, wherein said series of planned events in said treatment plan are of the type selected from the list of: medication change, appointment with care provider, check in with case manager, and conduct a reassessment of said treatment plan.

18. The method of claim 16, wherein at least one of said dates of said series of planned events also comprises a time for said event.

19. The method of claim 16, further comprising:
receiving, by said at least one application server, availability information for one or more treatment windows related to one or more of a plurality of treatment providers and to said client.

20. in a data processing network comprising two or more remote workstations, at least one application server running software for carrying out the steps according to the present method, and at least one secure, HIPPA-compliant database management system, all connected over one or more communications networks, a method of mental health case management, comprising the steps of:
generating, by said at least one application server, at least one query related to a physical or mental health status of a client;
transmitting, via said communications network, said at least one query to a first one of said at least one remote workstations accessible by said client;
receiving, by said at least one application server via said communications network, at least one encrypted response to said one or more queries from said first one of said at least one remote workstations;
generating, by said at least one application server, a time stamp indicating time of receipt by said at least one application server of said at least one encrypted response;
storing, on said database management system, said at least one encrypted response;
transmitting, via said communications network to a second one of said at least one remote workstations accessible by a care manager, said at least one encrypted responses; and
sorting, by said second one of said at least one remote workstations, said encrypted responses into time order via said corresponding time stamp; and
displaying, by said second one of said at least one remote workstations, said encrypted responses in said time order.

21. The method of claim 20, wherein said at least one remote workstations comprise a data-enabled mobile phone.

22. The method of claim 20, further comprising the steps of:
receiving, by said at least one application server via said communications network, at least one data transmission comprising Arabic characters to from said first one of said at least one remote workstations;
generating, by said at least one application server, a time stamp indicating time of receipt by said at least one application server of said at least one data transmission;
storing, on said database management system, said at least one data transmission;
transmitting, via said communications network to a second one of said at least one remote workstations accessible by a care manager, said at least one data transmission; and
sorting, by said second one of said at least one remote workstations, said data transmissions into time order via said corresponding time stamp; and
displaying, by said second one of said at least one remote workstations, said data transmissions and said encrypted responses in said time order.
